(19) United States
(12) Patent Application Publication
(10) Pub. No.: US 2020/0317850 A1
(43) Pub. Date: Oct. 8, 2020

(54) LOW CATHODIC DISBONDMENT COATING COMPOSITIONS

(71) Applicant: Dow Global Technologies LLC, Midland, MI (US)

(72) Inventors: Aayush Shah, Freeport, TX (US); Fabio Aguirre Vargas, Freeport, TX (US); Avery L. Watkins, Freeport, TX (US); Amber Stephenson, Freeport, TX (US)

(73) Assignee: Dow Global Technologies LLC, Midland, MI (US)

(21) Appl. No.: 16/305,211

(22) PCT Filed: May 22, 2017
(86) PCT No.: PCT/US2017/033744

§ 371 Date: Nov. 28, 2018

Related U.S. Application Data
(60) Provisional application No. 62/343,592, filed on May 31, 2016.

(51) Int. Cl. C08G 18/32; C08G 18/10; C08G 18/48; C08G 18/66; C08L 83/12; C09D 175/08

(52) U.S. Cl. CPC C08G 18/3206; C08G 18/10; C08G 18/4812; C09D 175/08; C08G 18/4854; C08G 18/6674; C08L 83/12; C08G 18/4816

(57) ABSTRACT

Embodiments of the present disclosure are directed to low cathodic disbondment coating compositions, more particularly, to polyurethane compositions including a butylene oxide based polyol composition that can be utilized to form polyurethane coatings having low cathodic disbondment. As an example, a low cathodic disbondment coating compositions can be formed from a polyurethane composition including a polyol composition that includes a butylene oxide based polyol composition, where the polyol composition has an average hydroxyl functionality from 2 to 8 and a hydroxyl equivalent weight from 150 to 4000, where the butylene oxide based polyol composition is from 10 weight percent to 100 weight percent of a total weight of the polyol composition and has an average hydroxyl functionality from 2 to 3, and a polyisocyanate composition, where the polyurethane composition has an isocyanate index in a range from 70 to 120.

### FIELD

Embodiments relate to low cathodic disbondment coating compositions, more particularly, to polyurethane compositions including a butylene oxide based polyol that can be utilized to form polyurethane coatings having low cathodic disbondment.

### BACKGROUND

Metal substrates such as metal pipes may be prone to corrosion. A degree and timeline for such corrosion may be based on a type of the metal substrate and/or a type of an environment to which the metal substrate is exposed. Protective coatings in conjunction with cathodic protection (CCCP) can be used to prevent the onset of corrosion on metal substrates. However, such protective coatings may experience cathodic disbondment, for instance, due to a cathodic reduction reaction. For example, cathodic disbondment of the protective coating from the metal substrate can occur when the electric potential of a metal substrate is less than a corrosion potential because of an accumulation of ions (e.g., hydrogen ions) across a surface of the metal substrate, among other possibilities.

### BRIEF DESCRIPTION OF THE DRAWINGS

FIG. 1 illustrates a view of an example embodiment of low cathodic disbondment coating composition according to the present disclosure.

FIG. 2 illustrates a view of a portion of a comparative example of a coating composition according to the present disclosure.

### SUMMARY

The present disclosure provides polyurethane compositions that include a polyol composition including a butylene oxide based polyol composition, where the polyol composition has an average hydroxyl functionality from 2 to 8 and a hydroxyl equivalent weight from 150 to 4000, where the butylene oxide based polyol composition is from 10 weight percent to 100 weight percent of a total weight of the polyol composition and has an average hydroxyl functionality from 2 to 3, and a polyisocyanate composition, where the polyurethane composition has an isocyanate index in a range from 70 to 120.

The present disclosure provides polyurethane coatings formed from polyol compositions including a butylene oxide based polyol composition. In various embodiments, the polyurethane coatings, when cured, have a cathodic disbondment of less than 12 millimeters as measured in accordance with the ASTM G95.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Metal substrates such as metal pipes may be prone to corrosion. A degree and timeline for such corrosion may be based on a type of the metal substrate and/or a type of an environment to which the metal substrate is exposed. Protective coatings in conjunction with cathodic protection (CCCP) can be used to prevent the onset of corrosion on metal substrates. However, such protective coatings may experience cathodic disbondment, for instance, due to a cathodic reduction reaction. For example, cathodic disbondment of the protective coating from the metal substrate can occur when the electric potential of a metal substrate is less than a corrosion potential because of an accumulation of ions (e.g., hydrogen ions) across a surface of the metal substrate, among other possibilities.

Polyurethanes may be used in a variety of applications, for example, as protective coatings. Depending upon an application, a particular aesthetic quality and/or mechanical performance of polyurethane may be desired. Polyols are used to form polyurethanes. Qualities of the polyols and/or other components such as fillers can influence properties of a resultant polyurethane and/or products such as protective coatings formed therefrom.

As such, with respect to varying properties of polyurethanes depending upon an application thereof, one method is to vary a structure and/or a composition of a polyol used in the manufacture of the polyurethane. However, varying a structure and/or a composition of a polyol may have an undesirable impact on other properties (e.g., a decreased durability and/or increased amount of cathodic disbondment) of the resultant polyurethane. For example, as discussed U.S. Pat. No. 5,391,686, fillers such as calcium oxide, silica based fillers (e.g., fumed silica), molecular sieves such as zeolites can assist in viscosity control of the liquid polyurethane. Similarly, EP 568388 describes a polyurethane composition formed with castor oil and fillers. However, use of fillers and/or castor oil when forming polyurethanes may be undesirable, for example, due to limited availability of castor oil, and/or may be undesirable as filled systems are significantly harder to stabilize and hence the fillers has the tendency to settle and form a hard layer at bottom of the container, which may be difficult to re-disperse. In addition, fillers can impart wear on and/or wear out the application equipment such as spray machines.

Further, as discussed in WO Patent Application No. 2105/050811 and U.S. Patent publication No. 2011/0098417, polyurethane-polyurea polymer system allow for high reactivity, speed of application, and strength and toughness as compared to polyurethanes formed from other types of polyols used to protect frac tanks. However, use of polyurea polymer systems may be undesirable for various reasons and/or applications and may not have desired cathodic disbondment properties (e.g., may not have a cathodic disbondment of less than 12 millimeters in accordance with ASTM G95).

A need exists for polyol compositions that promotes desired properties in resultant polyurethanes without undesirably impacting other properties of the resultant polyurethane and/or without employing undesired components such as fillers and/or castor oil. Accordingly, embodiments of the present disclosure are directed to polyurethane compositions and low cathodic disbondment coating compositions formed therefrom. Notably, the polyurethane compositions and the resultant low cathodic disbondment coating compositions are substantially free of castor oil and fillers and yet exhibit desired mechanical properties (e.g., a cathodic disbondment of less than 12 millimeters as measured in accordance with the ASTM G95). In various embodiments, the low cathodic disbondment coating compositions (e.g., a polyurethane coating) have cathodic disbondment of less than 10 millimeters as measured in accordance with the ASTM G95. That is, as used herein, low cathodic disbondment refers to a cathodic disbondment of less than 12 millimeters as measured in accordance with the ASTM G95 and, preferably, a cathodic disbondment less than 10 millimeters as measured in accordance with the ASTM G95. Such low cathodic disbondment coating compositions (e.g., a polyurethane coating) with can desirably be used to protect an epoxy primer from damage and/or weathering.

Various embodiments of the present disclosure provide polyurethane compositions including a polyol composition including a butylene oxide based polyol composition and a polyisocyanate composition. As used herein, a “polyol” refers to an organic molecule, e.g., polyether, having an average hydroxyl functionality of greater than 1.0 hydroxyl groups per molecule. For instance, a “diol” refers to an organic molecule having an average hydroxyl functionality of 2 and a “triol” refers to an organic molecule having an average hydroxyl functionality of 3.

As used herein, a “average hydroxyl functionality” (i.e., an average nominal hydroxyl functionality) refers to a number average functionality, e.g., a number of hydroxyl groups per molecule, of a polyol or a polyol composition based upon a number average functionality, e.g., a number of active hydrogen atoms per molecule, of initiator(s) used for preparation. As used herein, “average” refers to number average unless indicated otherwise.

The polyol composition has an average hydroxyl functionality from 2 to 8. All individual values and subranges from 2 to 8 average hydroxyl functionality of the polyol composition are included; for example, the polyol composition can have from a lower limit of 2 average hydroxyl functionality, 2 average hydroxyl functionality, 3 average hydroxyl functionality or 4 average hydroxyl functionality to an upper limit of 8 average hydroxyl functionality, 7 average hydroxyl functionality, 6 average hydroxyl functionality, or 5 average hydroxyl functionality of the polyol composition.

The polyol composition has a hydroxyl equivalent weight from 150 to 4000. All individual values and subranges from 150 to 4000 hydroxyl equivalent weight of the polyol composition are included; for example, the polyol composition can have from a lower limit of 150 hydroxyl equivalent weight, 300 hydroxyl equivalent weight, 1000 hydroxyl equivalent weight or 2000 hydroxyl equivalent weight to an upper limit of 4000 hydroxyl equivalent weight, 3500 hydroxyl equivalent weight, 3000 hydroxyl equivalent weight, or 2500 hydroxyl equivalent weight of the polyol composition.

The butylene oxide based polyol composition may be comprised of a diol and/or a triol. For instance, in various embodiments, the butylene oxide based polyol can be a mixture of a butylene oxide based diol and a butylene oxide based triol. Such mixtures can include from 1 to 99 weight percent butylene oxide based diols and can included from 99 to 1 weight percent butylene oxide based diols. All individual values and subranges from 1 to 99 and 99 to 1 are included. In various embodiments, the butylene oxide based polyol can have an average hydroxyl functionality from 2 to 3. In some embodiments, the butylene oxide based polyol (e.g., a mixture of a butylene oxide based diol and a butylene oxide based triol) a can have an average hydroxyl functionality of 2.7.

In various embodiments, the butylene oxide based polyol composition can include a polyoxyalkylene diol having an average hydroxyl functionality of 2. Examples of suitable polyoxyalkylene diols include those formed from and/or including butylene oxide and propylene oxide block copolymers. The polyoxyalkylene diol may be obtained commercially. Examples of commercial polyoxyalkylene diols include, but are not limited to, polyoxyalkylene diols sold under the trade name VORAPEL™, available from The Dow Chemical Company.

In various embodiments, the butylene oxide based polyol composition can include a polyoxyalkylene triol having an average hydroxyl functionality of 3. Examples of suitable polyoxyalkylene triols include those formed from and/or including butylene oxide and propylene oxide block copolymers. The polyoxyalkylene triols may be obtained commercially. Examples of commercial polyoxyalkylene triols include, but are not limited to, polyoxyalkylene triols sold under the trade name VORAPEL™, available from The Dow Chemical Company. Further, a hydroxyl-containing initiator compound can be used with the alkylene oxide to form the butylene oxide based polyol, among other possibilities.

As mentioned, in various embodiments, the butylene oxide based polyol composition can be formed of a butylene oxide and propylene oxide block copolymer. Relative amounts of butylene oxide and propylene oxide in the propylene oxide block copolymer can be varied. For example, the butylene oxide can be from 10 wt % to 90 wt % of a total weight of the butylene oxide and propylene oxide block copolymer. All individual values and subranges from 10 wt % to 90 wt % are included. For example, an amount of butylene oxide in the butylene oxide and propylene oxide block copolymer can be from a lower limit of 10 wt %, 20 wt %, 25 wt % to an upper limit of 30 wt %, 40 wt %, 60 wt %, or 90 wt % of the total weight of the polyurethane compositions.

Similarly, the propylene oxide can be from 10 wt % to 65 wt % of a total weight of the butylene oxide and propylene oxide block copolymer. All individual values and subranges from 10 wt % to 65 wt % are included. While the ranges are recited with regard to a total weight of a butylene oxide and propylene oxide in the propylene oxide block copolymer the disclosure is not so limited. Rather, butylene oxide based polyol composition can be a block copolymer formed of butylene oxide and a different polymer (e.g., ethylene) in some embodiments.

In various embodiments, a total weight of the butylene oxide and propylene oxide block copolymer in the polyol composition is from 15 to 90 weight percent butylene oxide. All individual values and subranges from 15 wt % to 90 wt % are included.

Notably, in some embodiments, at least a portion of total weight of the butylene oxide and propylene oxide block copolymer in the polyurethane composition is attributable to a prepolymer (e.g., Prepolymer 1) in a polyisocyanate composition. That is, in some embodiments, a total weight of the prepolymer included in the polyisocyanate composition is from 15 to 75 weight percent butylene oxide. All individual values and subranges from 15 wt % to 75 wt % are included.

In various embodiments, the butylene oxide based polyol composition can be a nonpolar butylene oxide based polyol composition. Examples of nonpolar butylene oxide based polyols compositions include those formed of and/or derived from butylene oxide and propylene oxide block copolymers, as described herein.

In various embodiments, the polyol compositions, the polyurethane compositions, and resultant polyurethane coatings are substantially free of castor oil and substantially free of fillers. That is, in various embodiments, the polyurethane compositions and polyurethane coating formed therefrom are substantially free of both castor oil and fillers.

Castor oil has the formula CH3-(CH2)5-CH(OH)—CH2-CH═CH—(CH2)7-COOH with average hydroxyl functionality of 2.7. Examples of fillers, but are not limited to, those discussed U.S. Pat. No. 5,391,686 and EP 568388 (e.g., molecular sieves such as zeolites or zeolite containing castor oil, calcium carbonate, calcium oxide, fumed silica, and other mineral fillers.

As used herein, being substantially free of Castor oil refers to having from 8 wt % to 0 wt % of a total weight of a component (e.g., a polyurethane coating) formed from castor oil. All individual values and subranges from 8 wt % to 0 wt % are included. For example, an amount of castor oil in a polyurethane composition can be from a lower limit of 0 wt %, 0.1 wt %, 0.6 wt % 1 wt % or 2 wt % to an upper limit of 8 wt %, 4 wt %, 3 wt %, or 2.5 wt % of the total weight of the polyurethane compositions. It is noted that in some embodiments, castor oil is 0 wt % of a total weight of a polyurethane composition and similarly 0 wt % of a total weight of a resultant polyurethane coating formed therefrom.

As used herein, being substantially free of a filler refers to having from 4 wt % to 0 wt % of a total weight of a component (e.g., a polyurethane coating) formed from a filler. In various examples, an amount of filler in the polyurethane compositions can be from a lower limit of 0 wt %, 0.1 wt %, 0.5 wt % 1 wt % or 2 wt % to an upper limit of 4 wt %, 3 wt %, or 2.5 wt % of the total weight of the polyurethane compositions. It is noted that in some embodiments, a filler is 0 wt % of a total weight of the polyurethane composition and similarly 0 wt % of a total weight of a polyurethane coating formed therefrom.

Embodiments of the present disclosure provide that the isocyanate is a polyisocyanate. As used herein, “polyisocyanate” refers to a molecule having an average of greater than 1.0 isocyanate groups per molecule.

Examples of polyisocyanates include, but are not limited to, alkylene diisocyanates such as 1,12-dodecane diisocyanate; 2-ethyltetramethylene 1,4-diisocyanate; 2-methyl-pentamethylene 1,5-diisocyanate; 2-ethyl-2-butylpentamethylene 1,5-diisocyanate; tetramethylene 1,4-diisocyanate; and hexamethylene 1,6-diisocyanate. Examples of polyisocyanates include, but are not limited to cycloaliphatic diisocyanates, such as cyclohexane 1,3- and 1,4-diisocyanate and mixtures of these isomers; 1-isocyanato-3,3,5-trimethyl-5-isocyanato-methylcyclohexane; 2,4- and 2,6-hexahydrotolylene diisocyanate; and the corresponding isomer mixtures, 4,4-, 2,2′- and 2,4′-dicyclohexylmethane diisocyanate; and corresponding isomer mixtures. Examples of polyisocyanates include, but are not limited to, araliphatic diisocyanates, such as 1,4-xylylene diisocyanate and xylylene diisocyanate isomer mixtures. Examples of polyisocyanates include, but are not limited to, aromatic polyisocyanates, e.g., 4,4′-, 2,4′- and 2,2′-diphenylmethane diisocyanate and the corresponding isomer mixtures, mixtures of 4,4′- and 2,4′-diphenylmethane diisocyanates, polyphenyl-polymethylene polyisocyanates, mixtures of 4,4′-, 2,4′- and 2,2′-diphenylmethane diisocyanates and polyphenyl-polymethylene polyisocyanates (crude MDI). The polyisocyanate may be employed individually or in combinations thereof. Isocyanate prepolymers, i.e. isocyanates prereacted with a part of a polyether polyol blend of the present application, or with a different polyol, can also be used. Also, modified isocyanates, e.g., isocyanates modified through trimerization, carbodiimide formation, biuret and/or allophanate reactions for instance, may be utilized.

For the various embodiments, examples of suitable polyisocyanates include, but are not limited to, aliphatic, cycloaliphatic, aromatic and heterocyclic polyisocyanates, dimers and trimers thereof and mixtures thereof. For the various embodiments, the polyisocyanate of the present disclosure can have a functionality of at least 2, where the functional group for the polyisocyanate is defined as the number of isocyanate (—N═C═O) functional groups per molecule.

Useful cycloaliphatic polyisocyanates include those in which one or more of the isocyanate groups are attached directly to the cycloaliphatic ring and cycloaliphatic polyisocyanates in which one or more of the isocyanate groups are not attached directly to the cycloaliphatic ring. Useful aromatic polyisocyanates include those in which one or more of the isocyanate groups are attached directly to the aromatic ring, and aromatic polyisocyanates in which one or more of the isocyanate groups are not attached directly to the aromatic ring. Useful heterocyclic polyisocyanates include those in which one or more of the isocyanate groups are attached directly to the heterocyclic ring and heterocyclic polyisocyanates in which one or more of the isocyanate groups are not attached directly to the heterocyclic ring.

The isocyanate can be prepared by phosgenation of corresponding polyamines with formation of polycarbamoyl chlorides and thermolysis thereof to provide the polyisocyanate and hydrogen chloride, or by a phosgene-free process, such as by reacting the corresponding polyamines with urea and alcohol to give polycarbamates, and thermolysis thereof to give the polyisocyanate and alcohol, for example. The isocyanate may be obtained commercially. Examples of commercial isocyanates include, but are not limited to, isocyanates sold under the trade names VORANATE™ and ISONATE™, available from The Dow Chemical Company.

Embodiments of the present disclosure provide that the polyisocyanate can have a number average isocyanate equivalent weight from 100 to 160. All individual values and subranges from 100 to 160 are included; for example, the polyisocyanate can have a number average isocyanate equivalent weight from a lower limit of 100, 105, or 110 to an upper limit of 160, 155, 150, or 144.

The polyisocyanate can be utilized, for example, such that a polyurethane composition has an isocyanate index in a range from 70 to 120. Isocyanate index can be defined as a quotient, multiplied by one hundred, of an actual amount of isocyanate utilized and a theoretical amount of isocyanate for curing. All individual values and subranges from 70 to 120 are included; for example, the polyurethane composition can have an isocyanate index from a lower limit of 70, 75, or 80 to an upper limit of 120, 103, or 100.

For the various embodiments, the polyurethane composition can further include at least one additive. Such additives can include, but are not limited to, light stabilizers, heat stabilizers, antioxidants, colorants, fire retardants, ultraviolet light absorbers, light stabilizers such as hindered amine light stabilizers, wetting agents, crosslinking components, adhesion agents, mold release agents, static (non-photochromic) dyes, fluorescent agents, pigments, surfactants, chain extenders, flexibilizing additives, and combinations thereof. Depending upon an intended application types and/or amounts of additives can be varied. Similarly, depending upon an intended application a type and/or amount of catalyst can be varied.

In various examples, the polyurethane composition can include a chain extender. Examples of chain extenders include but are not limited to ethylene glycol, diethylene glycol, triethylene glycol, propylene oxide, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, sorbitol and sucrose, as well as alkoxylates, and combinations thereof. The chain extenders may be obtained commercially. Examples of commercial chain extenders include, but are not limited to, propylene oxide based chain extenders sold under the trade name POLYGLYCOL™, available from The Dow Chemical Company, and 1,4, butanediol sold under the trade name DIPRANE′ available from The Dow Chemical Company.

In various examples, the polyurethane composition can include a Butylene oxide based polyol 2. The Butylene oxide based polyol 2 can be a trifunctional polyoxyalkylene triol having a number average equivalent weight of from approximately 150 to 400. The Butylene oxide based polyol 2 may be obtained commercially. Examples of commercial Butylene oxide based polyol 2 include, but are not limited to, triols sold under the trade name VORAPEL™ available from The Dow Chemical Company.

In various examples, the polyurethane composition can include an adhesion agent. The adhesion agent can be an epoxy silane. The adhesion agent may be obtained commercially. Examples of commercial adhesion agents include, but are not limited to, adhesion agents sold under the trade name SILQUEST™, available from MOMENTIVE™.

In various examples, the polyurethane composition can include a catalyst. Examples of suitable catalysts include amine catalysts, Lewis Acid catalysts, bismuth-based catalysts, and/or Tin based catalyst, among others catalysts.

Amine Catalyst

Examples of amine catalysts include pentamethyldiethylene-triamine, triethylamine, tributyl amine, dimethylethanolamine, N,N,N′,N-tetra-methylethylenediamine, dimethylbenzylamine, N,N,N′,N′-tetramethylbutanediamine, dimethylcyclohexylamine, triethylenediamine, and combinations thereof, among other amine catalysts.

Lewis Acid Catalyst

The metal based Lewis acid catalyst has the general formula M(R⁵)₁(R⁶)₁(R⁷)₁(R⁸)ₐ, where a is 0 or 1, whereas M is boron, aluminum, indium, bismuth or erbium, R⁵ and R⁶ each independently includes a fluoro-substituted phenyl or methyl group, R⁷ includes a fluoro-substituted phenyl or methyl group or a functional group or functional polymer group, optional R⁸ is a functional group or functional polymer group. By fluoro-substituted phenyl group it is meant a phenyl group that includes at least one hydrogen atom replaced with a fluorine atom. By fluoro-substituted methyl group it is meant a methyl group that includes at least one hydrogen atom replaced with a fluorine atom. R⁵, R⁶, and R⁷ may include the fluoro-substituted phenyl group or may consist essentially of the fluoro-substituted phenyl group. R⁵, R⁶, and R⁷ may include the fluoro-substituted methyl group, for example, in the form of a fluoro-substituted methyl group bonded with a sulfuroxide (e.g., sulfoxide, sulfonly, sulfone and the like). The M in the general formula may exist as a metal salt ion or as an integrally bonded part of the formula.

The functional group or functional polymer group may be a Lewis base that forms a complex with the Lewis acid catalyst (e.g., a boron-based Lewis acid catalyst or a metal triflate catalyst). By functional group or functional polymer group it is meant a molecule that contains at least one of the following: an alcohol, an alkylaryl, a linear or branched alkyl having 1-12 carbon atoms, a cycloalkyl, a propyl, a propyl oxide, a mercaptan, an organosilane, an organosiloxane, an oxime, an alkylene group capable of functioning as a covalent bridge to another boron atom, a divalent organosiloxane group capable of functioning as a covalent bridge to another boron atom, and substituted analogs thereof. For example, the functional group or functional polymer group may have the formula (OYH)n, whereas O is O oxygen, H is hydrogen, and Y is H or an alkyl group. However, other known functional polymer groups combinable with a Lewis acid catalyst such as a boron-based Lewis acid catalyst or metal triflate may be used.

The Lewis acid catalyst may be a metal triflate. For example, the metal triflate has the general formula M(R⁵)₁(R⁶)₁(R⁷)₁(R⁸)a, where a is 0 or 1, whereas M is aluminum, indium, bismuth or erbium, and R⁵, R⁶, and R⁷ are each CF₃SO₃. The Lewis acid catalyst may be active at a lower temperature range (e.g., from 60° C. to 110° C.). Exemplary references include U.S. Pat. No. 4,687,755; Williams, D. B. G.; Lawton, M. Aluminium triflate: a remarkable Lewis acid catalyst for the ring opening of epoxides by alcohols. Org. Biomol. Chem. 2005, 3, 3269-3272; Khodaei, M. M.; Khosropour, A. R.; Ghozati, K. Tetrahedron Lett. 2004, 45, 3525-3529; Dalpozzo, R.; Nardi, M.; Oliverio, M.; Paonessa, R.; Procopio, A. Erbium(III) triflate is a highly efficient catalyst for the synthesis of β-alkoxy alcohols, 1,2-diols and β-hydroxy sulfides by ring opening of epoxides. Synthesis 2009, 3433-3438.

The Lewis acid catalyst used in various embodiments may be a blend catalyst that includes one or more Lewis acid catalyst (e.g., each having the general formula B(R⁵)₁(R⁶)₁(R⁷)₁(R⁸)_{0 or 1}, whereas R⁵ and R⁶ are each independently a fluoro-substituted phenyl or methyl group, R⁷ is a fluoro-substituted phenyl or methyl group or a functional group or functional polymer group, optional R⁸ is the functional group or functional polymer group). The blend catalyst may optional include other catalysts. Metal-based Lewis acids are based on one of aluminum, boron, copper, iron, silicon, tin, titanium, zinc, and zirconium.

The catalyst may be obtained commercially. Examples of commercial catalysts include, but are not limited to, bismuth-based catalysts sold under the trade name REAXIS™ available from REAXIS™ and Tin based catalysts sold under the trade name FOMREZ™, available from Momentive Chemicals™.

In various examples, the polyurethane composition can include a pigment. Examples of suitable pigments include titanium dioxide, iron oxide, among others. The pigment may be obtained commercially. Examples of commercial pigments include, but are not limited to, titanium oxide pigments sold under the trade name TIPURE™ R-900, available from DUPONT™.

In various examples, the polyurethane composition can include a crosslinking component. Examples of suitable crosslinking components include but are not limited to multifunctional amines, thiols, phenolics, and carboxylic acids. The crosslinking component may be obtained commercially. Examples of commercial crosslinking components include, but are not limited to, crosslinking components sold under the trade name VORANOL™, available from The Dow Chemical Company.

In various examples, the polyurethane composition can include a prepolymer. The prepolymer can be a MDI prepolymer, a PMDI prepolymer, and mixtures thereof. Suitable prepolymers are prepolymers having a functionality [—N═C═O] content of from 2 to 40 wt %, more preferably from 4 to 30 wt %. These prepolymers are prepared by reaction of the di- and/or poly-isocyanates with materials including lower molecular weight diols and triols, but also can be prepared with multivalent active hydrogen compounds such as di- and tri-amines and di- and tri-thiols. Individual examples include aromatic polyisocyanates containing urethane groups, preferably having a functionality [—N═C═O] content of from 5 to 40 wt %, more preferably 15 to 35 wt %, obtained by reaction of diisocyanates and/or polyisocyanates with, for example, polyols such as lower molecular weight diols, triols, oxyalkylene glycols, dioxyalkylene glycols, or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene polyoxyethylene glycols can be used. Polyester polyols can also be used, as well as alkyl diols such as butane diol. Other diols also useful include bishydroxyethyl- or bishydroxypropyl-bisphenol A, cyclohexane dimethanol, and bishydroxyethyl hydroquinone.

In various examples, the polyurethane composition can include a wetting agent. Examples of suitable wetting agents include but are not limited to anionic, nonionic and cationic surfactants and combinations thereof. The wetting agent may be obtained commercially. Examples of commercial wetting agents include, but are not limited to, wetting agents old under the trade name BYK-333®, available from Byk Additives, Inc.

As mentioned, a polyurethane coating can be formed by curing a polyurethane composition, as described herein. In various embodiments, butylene oxide is from 1 percent to 90 percent of a total weight of the polyurethane coating (i.e., the cured polyurethane coating). All individual values and subranges from 1 to 90 wt %, of the polyurethane coating included; for example, the polyol composition can have from a lower limit of 1 wt %, 5 wt %, 10 wt % to an upper limit of 90 wt %, 75 wt %, wt %, or 65 wt %.

All parts and percentages are by weight unless otherwise indicated.

### Examples

Analytical Methods:

OH number can be calculated as =33 x % OH, with % OH=1700/hydroxyl equivalent weight of the polyol.

Hydroxyl equivalent weight of the polyol=MW of the polyol/functionality.

Isocyanate index: Isocyanate index values are equal to a quotient, multiplied by one hundred, of an actual amount of isocyanate utilized and a theoretical amount of isocyanate for curing.

Cathodic Disbondment:

Cathodic disbondment is determined in accordance with ASTM G95 (Standard Test Method for Cathodic Disbondment of Pipeline Coatings (Attached Cell Method)). The ASTM G95 test method covers accelerated procedures for simultaneously determining comparative characteristics of coating systems applied to steep pipe exterior for the purpose of preventing or mitigating corrosion that may occur in underground service where the pipe will be in contact with natural soils and will receive cathodic protection. Generally, the ASTM G95 test method subjects the coating on the test specimen to electrical stress in a highly conductive alkaline electrolyte. Electrical stress is obtained from an impressed direct-current system. An intentional holiday is to be made in the coating prior to starting of test. A 10 centimeter diameter cylinder is placed around the holiday at the center of the coated panel and a 3 percent sodium chloride solutions is added to this cylinder. Electrical instrumentation is provided for measuring the current and the potential throughout the test cycle. At the conclusion of the test period, a utility knife is used to chip away as much of the coating near the holiday as possible, and the test specimen is physically examined. Physical examination is conducted by measuring the extent of disbonded coating at the intentional holiday in millimeters.

The following materials are principally used:
Butylene oxide based polyol 1 A hydrophobic difunctional polyoxyalkylene diol having a number average equivalent weight of approximately 1001 (available from The Dow Chemical Company as VORAPEL™ D3201) formed from propylene oxide and butylene oxide.
Castor oil Castor oil (available from available from LINTECH′).
Adhesion agent A epoxy silane (available from Momentive™ as SILQUEST™ A187).
Catalyst 1 A Bismuth Carboxylate (available from REAXIS™ as REAXIS™ C716).
Catalyst 2 A dimethyltin dineodecanoate (available from Momentive as Fomrex™ UL-28)
Chain extender 1 A 1,4, butanediol having a number average equivalent weight of approximately 45 (available from The Dow Chemical Company as DIPRANE′).
Chain extender 2 A difunctional polypropylene glycol having an number average equivalent weight of approximately 70 (available from The Dow Chemical Company as POLYGLYCOL™ P 425
Pigment A titanium dioxide pigment (available from TIPURE™ R-900, available from DUPONT™)
Polyisocyanate A polycarbodiimide-modified diphenylmethane diisocyanate having an isocyanate equivalent weight of approximately 145 (available from The Dow Chemical Company as ISONATE™ 143L).
Crosslinking component A polyether polyol having four functional groups and a number average equivalent weight of approximately 70 (available from The Dow Chemical Company as VORANOL™ 800).
Butylene oxide based polyol 2 A hydrophobic trifunctional polyoxyalkylene triol having a number average equivalent weight of approximately 197 (available from The Dow Chemical Company as VORAPEL™ T5001).
Prepolymer 1 A VORAPEL′ based prepolymer having an isocyanate (NCO) content of approximately 16.5 wt % NCO (available from The Dow Chemical Company as VORASTAR™ 7000).
Prepolymer 2 A polyprepoylene oxide based prepolymer having an isocyanate (NCO) content of approximately 10.3 wt % NCO (available from The Dow Chemical Company as HYPERLAST™ LE 5006).
Wetting Agent A polyether modified polydimethylsiloxane (available from Byk Additives, Inc. under the name BYK-333®).

Working Example 1 and Comparative Example A are prepared using the above materials in various amounts as outlined in Table 1, below.

TABLE 1

| | Material | Weight (gram) |
|---|---|---|
| Ex. 1 | Butylene oxide based polyol 1 | 19.00 |
| | Chain extender 1 | 9.00 |
| | Butylene oxide based polyol 2 | 24.00 |
| | Cross linking component | 9.73 |
| | Chain extender 2 | 18.01 |
| | Colorant | 1.00 |
| | Adhesion agent | 3.00 |
| | Catalyst 1 | 0.05 |
| | Catalyst 2 | 0.02 |
| | Wetting Agent | 0.50 |
| | Prepolymer 1 | 33.83 |
| | Polyisocyanate | 66.23 |
| CE. A | Castor oil | 32.42 |
| | Chain extender 1 | 7.56 |
| | Crosslinking component | 9.73 |
| | Chain extender 2 | 27.01 |
| | Adhesion agent | 3.00 |
| | Catalyst 1 | 0.05 |
| | Catalyst 2 | 0.02 |
| | Wetting Agent | 0.50 |
| | Prepolymer 2 | 26.82 |
| | Polyisocyanate | 68.92 |

Working Example 1 is a polyol composition including a butylene oxide based polyol composition. Notably, the polyol composition of Working Example 1 is does not include castor oil. Further note, the polyol composition of Working Example 1 is does not include a filler. Working Example 1 is prepared using the following method:

As detailed in Table 1, respective amounts of Butylene oxide based polyol 1, Chain extender 1, Butylene oxide based polyol 2, Cross linking component, Chain extender 2, Colorant, Adhesion agent, Catalyst 1, Catalyst 2, and Wetting Agent are added to a 200 milliliter first Flacktek™ cup of a Flacktek™ Speedmixer (model # DAC 600.1 FVZ) to form a polyol composition including a butylene oxide based polyol composition (Butylene oxide based polyol 1 and Butylene oxide based polyol 2) in the first Flacktek™ cup. The polyol composition is then degassed by placing the first Flacktek™ cup in a vacuum chamber until substantially all gas bubbles are removed from the polyol composition as confirmed by visual inspection.

Additionally, as detailed in Table 1, respective amounts of Prepolymer 1 and Polyisocyanate are added to a 200 milliliter second Flacktek™ cup of a Flacktek™ Speedmixer (model #? DAC 600.1 FVZ) to form a polyisocyanate composition in the second Flacktek™ cup. The polyisocyanate composition is then degassed by placing the second Flacktek™ cup in a vacuum chamber until substantially all gas bubbles are removed from the polyisocyanate composition as confirmed by visual inspection. The degassed polyisocyanate composition is then added the polyol composition in the first Flacktek™ cup. Upon addition of the degassed polyisocyanate composition to the first Flacktek™ cup, the reaction mixture is mixed for 5 seconds by rotation of the first Flacktek™ cup at approximately 2350 rotations per minute to form a polyurethane composition.

The polyurethane composition is then applied directly (without an intervening component such as a primer, etc.) to a steel substrate and drawn across the surface of the steel substrate with a drawbar to form a 50 mils thick polyurethane coating on the surface of the steel substrate. The polyurethane coating is allowed to cure at ambient temperature of approximately 23° C. and ambient pressure of approximately 100 kPa.

Comparative Example A (i.e., CE. A) is polyol composition including castor oil. As detailed in Table 1, respective amounts of castor oil, Chain extender 1, Crosslinking component, Chain extender, Adhesion agent, Catalyst 1, Catalyst 2, and Wetting Agent, are added to a 200 milliliter first Flacktek™ cup of a Flacktek™ Speedmixer model # DAC 600.1 FVZ to form a polyol composition in the first Flacktek™ cup. The polyol composition is then degassed by placing the first Flacktek™ cup in a vacuum chamber until substantially all gas bubbles are removed from the polyol composition as confirmed by visual inspection.

Additionally, as detailed in Table 1, respective amounts of Prepolymer 2 and polyisocyanate are added to a 200 milliliter) second Flacktek™ cup of a Flacktek™ Speedmixer model # DAC 600.1 FVZ to form a polyisocyanate composition in the second Flacktek™ cup. The polyisocyanate composition is then degassed by placing the second Flacktek™ cup in a vacuum chamber until substantially all gas bubbles are removed from the polyisocyanate composition as confirmed by visual inspection. The degassed polyisocyanate composition is then added the polyol composition in the first Flacktek™ cup. Upon addition of the degassed polyisocyanate composition to the first Flacktek™ cup, the reaction mixture is mixed for 5 seconds by rotation of the first Flacktek™ cup at approximately 2350 rotations per minute to form a polyurethane composition.

The polyurethane composition is then applied directly (without an intervening component such as a primer, etc.) to a steel substrate and drawn across the surface of the steel substrate with a drawbar to form a 50 mils thick polyurethane coating on the surface of the steel substrate. The polyurethane coating is allowed to cure at ambient temperature of approximately 23° C. and ambient pressure of approximately 100 kPa.

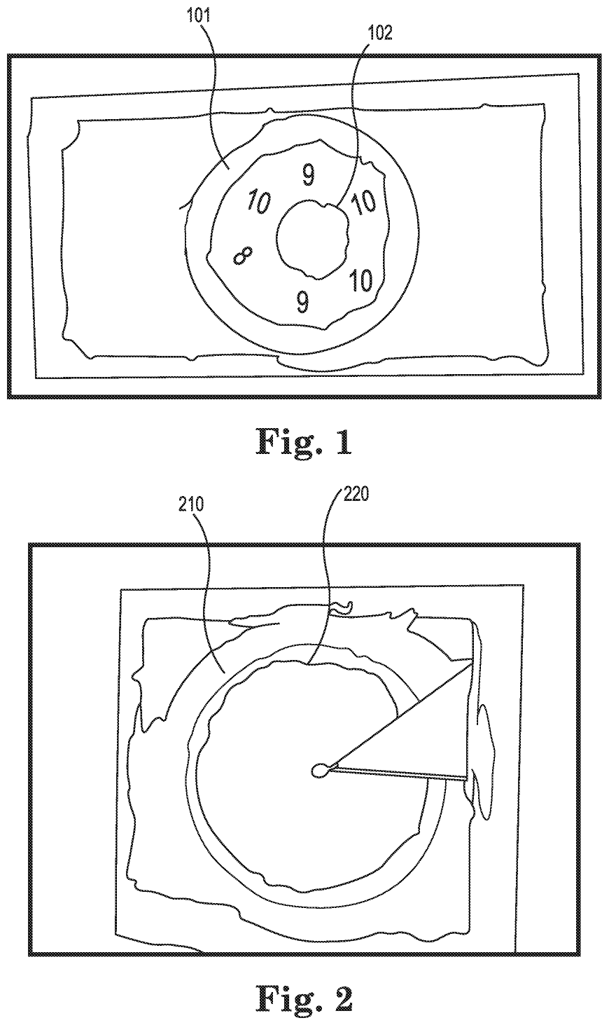

As shown in FIG. 1, once cured, the polyurethane coating 100 of Example 1 has cathodic disbondment identified in FIG. 1 by element identifier 102 of less than 12 millimeters as measured in accordance with the ASTM G95. Moreover, the polyurethane coating 100 of Example 1 has cathodic disbondment 102 of 10 millimeters or less as measured in accordance with the ASTM G95. As mentioned, the polyurethane coating 100 of Example 1 unexpectedly achieves this low amount of cathodic disbondment despite the absence of fillers and the absence of castor oil in the polyurethane coating 100 of Example 1.

In contrast, once cured, the polyurethane coating 210 of Comparative Example A has cathodic disbondment identified in FIG. 2 by element identifier 220 of greater than 12 millimeters as measured in accordance with the ASTM G95. Moreover, the polyurethane coating of Comparative Example A has cathodic disbondment 220 of at least 25 millimeters as measured in accordance with the ASTM G95. Notably, the polyurethane coating 210 of Comparative Example A does not include fillers. That is, without being limited to theory, it is believed that the absence of fillers in the polyurethane coating of 210 of Comparative Example A results in the high cathodic disbondment (e.g., greater than 12 millimeters).

That is, without being limited to theory, it is believed the desired low cathodic disbondment of Example 1 is attributable to the presence of the butylene oxide based polyol composition (e.g., a mixture of polyoxyalkylene diol and polyoxyalkylene triol in amounts described herein) in the polyol compositions and resultant compositions, described herein. That is, the low cathodic disbondment coating compositions, described herein, provide improved cathodic disbondment relative to various coating compositions such as those with castor oil.

1. A polyurethane composition, comprising:
a polyol composition including a butylene oxide based polyol composition, wherein the polyol composition has an average hydroxyl functionality from 2 to 8 and a hydroxyl equivalent weight from 150 to 4000, wherein the butylene oxide based polyol composition is from 10 weight percent to 100 weight percent of a total weight of the polyol composition and has an average hydroxyl functionality from 2 to 3; and
a polyisocyanate composition, wherein the polyurethane composition has an isocyanate index in a range from 70 to 120.

2. The polyurethane composition of claim 1, wherein the butylene oxide based polyol composition further comprises a butylene oxide and propylene oxide block copolymer.

3. The polyurethane composition of claim 2, wherein a total weight of the butylene oxide and propylene oxide block copolymer in the polyol composition is from 15 to 90 weight percent butylene oxide.

4. The polyurethane composition of claim 2, wherein a total weight of the butylene oxide and propylene oxide block copolymer in the polyurethane composition is from 15 to 95 weight percent butylene oxide.

5. The polyurethane composition of claim 1, wherein the butylene oxide based polyol composition comprises a nonpolar butylene oxide based polyol composition.

6. The polyurethane composition of claim 1, wherein the butylene oxide based polyol composition comprises is a polyoxyalkylene diol having an average hydroxyl functionality of 2 and a polyoxyalkylene triol having an average hydroxyl functionality of 3, and wherein the butylene oxide based polyol composition has an average hydroxyl functionality of 2 to 3.

7. The polyurethane composition of claim 1, wherein the polyurethane composition is substantially free of castor oil wherein the polyurethane composition is substantially free of a filler.

8. The polyurethane composition of claim 7, wherein the polyurethane composition has 0 weight percent castor oil, and wherein the polyurethane composition has 0.6 weight percent or less of a filler.

9. A polyurethane coating formed by curing the polyurethane composition of claim 1, wherein butylene oxide is from 1 percent to 90 percent of a total weight of the polyurethane coating when cured.

10. The polyurethane coating of claim 9, wherein the polyurethane coating has cathodic disbondment of less than 12 millimeters as measured in accordance with the ASTM G95.

11. A polyurethane coating, comprising:
a cured polyurethane composition formed of:
a polyol composition including a butylene oxide based polyol composition, wherein the polyol composition has an average hydroxyl functionality from 2 to 8 and a hydroxyl equivalent weight from 150 to 4000, wherein the butylene oxide based polyol composition is from 10 weight percent to 100 weight percent of a total weight of the polyol composition and has an average hydroxyl functionality of 2 to 3; and
a polyisocyanate composition including a prepolymer, wherein butylene oxide is from 15 to 75 weight percent of a total weight of the prepolymer, wherein the polyurethane composition has an isocyanate index in a range from 70 to 120.

12. The polyurethane coating of claim 11, wherein the polyurethane coating, when cured, has cathodic disbondment of less than 12 millimeters as measured in accordance with ASTM G95.
